(19) United States
(12) Patent Application Publication
(10) Pub. No.: US 2025/0069807 A1
(43) Pub. Date: Feb. 27, 2025

(54) THREE-TERMINAL MULTILAYER CERAMIC CAPACITOR

(71) Applicant: Murata Manufacturing Co., Ltd., Nagaokakyo-shi (JP)

(72) Inventor: Mitsuhiro OKUBO, Nagaokakyo-shi (JP)

(21) Appl. No.: 18/943,050

(22) Filed: Nov. 11, 2024

Related U.S. Application Data
(63) Continuation of application No. PCT/JP2023/013545, filed on Mar. 31, 2023.

(30) Foreign Application Priority Data
Jun. 17, 2022 (JP) 2022-097765

(51) Int. Cl. H01G 4/012; H01G 4/12; H01G 4/232; H01G 4/30

(52) U.S. Cl. CPC H01G 4/012; H01G 4/2325; H01G 4/30; H01G 4/1227; H01G 4/1236

(57) ABSTRACT

A three-terminal multilayer ceramic capacitor includes first to sixth extended electrode portions. The first and second extended electrode portions are connected to a first outer electrode at different portions of a first end surface. The third extended electrode portion is connected to the first outer electrode at a position spaced away from the first end surface on a second side surface. The fourth extended electrode portion is connected to a second outer electrode on a second end surface. The fifth extended electrode portion is connected to the second outer electrode at a position spaced away from the second end surface on the first side surface. The sixth extended electrode portion is connected to the second outer electrode at a position spaced away from the second end surface on the second side surface.

### CROSS REFERENCE TO RELATED APPLICATIONS

This application claims the benefit of priority to Japanese Patent Application No. 2022-097765 filed on Jun. 17, 2022 and is a Continuation Application of PCT Application No. PCT/JP2023/013545 filed on Mar. 31, 2023. The entire contents of each application are hereby incorporated herein by reference.

### BACKGROUND OF THE INVENTION

### 1. Field of the Invention

The present invention relates to three-terminal multilayer ceramic capacitors.

### 2. Description of the Related Art

Japanese Unexamined Patent Application Publication No. 2000-58376 discloses a multilayer feed-through ceramic capacitor having a general structure, that is, a three-terminal multilayer ceramic capacitor. This three-terminal multilayer ceramic capacitor includes a multilayer body and an outer electrode disposed on the outer surface of the multilayer body. The multilayer body includes an inner layer portion and an outer layer portion sandwiching the inner layer portion in a lamination direction. In the inner layer portion, a plurality of inner electrode layers are alternately disposed with a plurality of dielectric layers interposed therebetween, and are connected to the outer electrode. More specifically, the multilayer body has the outer surface including first and second main surfaces facing each other, first and second side surfaces facing each other, and first and second end surfaces. The inner electrode layers include a plurality of first inner electrode layers and a plurality of second inner electrode layers. The plurality of first inner electrode layers and the plurality of second inner electrode layers are alternately laminated in a predetermined lamination direction with a plurality of dielectric layers interposed therebetween. The first inner electrode layers are exposed to the first and second end surfaces. The second inner electrode layers are exposed to the first and second side surfaces. The first inner electrode layers are connected to the first and second outer electrodes on the first and second end surfaces, respectively. The second inner electrode layers are connected to the third and fourth outer electrodes on the first and second side surfaces, respectively. Such a three-terminal multilayer ceramic capacitor can improve high-frequency characteristics.

However, in the three-terminal multilayer ceramic capacitor of Japanese Unexamined Patent Application Publication No. 2000-58376, the junction area between the inner electrode layers and the outer electrodes is limited. This makes it difficult to reduce or prevent a DC resistance, and therefore difficult to reduce or prevent heat generation in the ceramic capacitor due to this DC resistance.

### SUMMARY OF THE INVENTION

Example embodiments of the present invention provide three-terminal multilayer ceramic capacitors each able to reduce or prevent heat generation.

A three-terminal multilayer ceramic capacitor according to an example embodiment of the present invention includes a multilayer body including a plurality of laminated dielectric layers and including a first main surface and a second main surface that face each other in a height direction, a first end surface and a second end surface that face each other in a length direction orthogonal or substantially orthogonal to the height direction, and a first side surface and a second side surface that face each other in a width direction orthogonal or substantially orthogonal to the height direction and the length direction, a plurality of first inner electrode layers on the plurality of dielectric layers and extending to the first end surface and the second end surface as well as the first side surface and the second side surface, a plurality of second inner electrode layers on the plurality of dielectric layers and extending to the first side surface and the second side surface, a first outer electrode on the first end surface, extending from the first end surface to a portion of the first main surface and a portion of the second main surface and to a portion of the first side surface and a portion of the second side surface, and connected to the first inner electrode layers, a second outer electrode on the second end surface, extending from the second end surface to a portion of the first main surface and a portion of the second main surface and to a portion of the first side surface and a portion of the second side surface, and connected to the first inner electrode layers, a third outer electrode on the first side surface, extending from the first side surface to a portion of the first main surface and a portion of the second main surface, and connected to the second inner electrode layers, and a fourth outer electrode on the second side surface, extending from the second side surface to a portion of the first main surface and a portion of the second main surface, and connected to the second inner electrode layers, wherein the first inner electrode layers each include a first counter electrode portion facing the second inner electrode layers with the plurality of dielectric layers interposed therebetween, a first extended electrode portion extending from the first counter electrode portion to the first end surface and connected to the first outer electrode, a second extended electrode portion extending from the first counter electrode portion or the first extended electrode portion and to the first side surface at a position spaced away from the first end surface on a first end surface side and connected to the first outer electrode, a third extended electrode portion extending from the first counter electrode portion or the first extended electrode portion to the second side surface at a position spaced away from the first end surface on the first end surface side and connected to the first outer electrode, a fourth extended electrode portion extending from the first counter electrode portion to the second end surface and connected to the second outer electrode, a fifth extended electrode portion extending from the first counter electrode portion or the fourth extended electrode portion to the first side surface at a position spaced away from the second end surface on a second end surface side and connected to the second outer electrode, and a sixth extended electrode portion extending from the first counter electrode portion or the fourth extended electrode portion to the second side surface at a position spaced away from the second end surface on the second end surface side and connected to the second outer electrode.

In the three-terminal multilayer ceramic capacitor according to an example embodiment of the present invention, the DC resistance in the first inner electrode layer can be reduced or prevented to reduce or prevent heat generation in the three-terminal multilayer ceramic capacitor, making it possible to obtain a three-terminal multilayer ceramic capacitor with excellent humidity resistance reliability and low ESL (equivalent series resistance) characteristics. This will be more specifically described below.

The first inner electrode layer includes the second extended electrode portion, third extended electrode portion, fifth extended electrode portion, and sixth extended electrode portion, in addition to the first extended electrode portion and fourth extended electrode portion. These extended electrode portions are connected to the first outer electrode and second outer electrode. Therefore, the junction area between the first inner electrode layer and the first and second outer electrodes is larger than the junction area when the first inner electrode layer is connected to the first and second outer electrodes only by the first and fourth extended electrode portions. This makes it possible to reduce or prevent the DC resistance in the first inner electrode layer, thus reducing or preventing the heat generation in the three-terminal multilayer ceramic capacitor.

In a top view, the first inner electrode layer is not exposed in a first multilayer body corner portion surrounded by the first and second extended electrode portions, a second multilayer body corner portion surrounded by the first and third extended electrode portions, a third multilayer body corner portion surrounded by the fourth and fifth extended electrode portions, and a fourth multilayer body corner portion surrounded by the fourth and sixth extended electrode portions. Therefore, even when moisture, a plating solution, or the like infiltrates the first to fourth multilayer body corner portion from outside of the three-terminal multilayer ceramic capacitor, such moisture, plating solution, or the like can be reduced or prevented from infiltrating into the multilayer body through the first inner electrode layer. This can improve the humidity resistance reliability of the three-terminal multilayer ceramic capacitor.

Furthermore, since the direction of a current flowing from the first inner electrode layer to the portion of the second inner electrode layer exposed on the first side surface is opposite to the direction of a current flowing from the second and fifth extended electrode portions toward the first counter electrode portion, an inductance (L component) generated by a magnetic field is cancelled out. Similarly, since the direction of a current flowing from the first inner electrode layer to the portion of the second inner electrode layer exposed on the second side surface is opposite to the direction of a current flowing from the third and sixth extended electrode portions toward the first counter electrode portion, an inductance (L component) generated by a magnetic field is cancelled out. A three-terminal multilayer ceramic capacitor having low ESL characteristics can thus be obtained.

Example embodiments of the present invention provide three-terminal multilayer ceramic capacitors each able to reduce or prevent heat generation.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is an external perspective view illustrating an example of a three-terminal multilayer ceramic capacitor according to an example embodiment of the present invention.

FIG. 2 is a top view illustrating an example of a three-terminal multilayer ceramic capacitor according to an example embodiment of the present invention.

FIG. 3 is a front view illustrating an example of a three-terminal multilayer ceramic capacitor according to an example embodiment of the present invention.

FIG. 4 is a cross-sectional view taken along line IV-IV in FIG. 1.

FIG. 5 is a cross-sectional view taken along line V-V in FIG. 1.

FIG. 6 is a cross-sectional view taken along line VI-VI in FIG. 4.

FIG. 7 is a cross-sectional view taken along line VII-VII in FIG. 4.

FIG. 8 is a plan view illustrating current flows in the multilayer ceramic capacitor in FIG. 1.

FIG. 9 is a partially enlarged view of FIG. 6.

FIG. 10 is a cross-sectional view of a three-terminal multilayer ceramic capacitor according to Comparative Example 1.

FIG. 11 is a cross-sectional view of a three-terminal multilayer ceramic capacitor according to Comparative Example 2.

### DETAILED DESCRIPTION OF THE EXAMPLE EMBODIMENTS

Example embodiments of the present invention will be described in detail below with reference to the drawings.

### 1. Three-Terminal Multilayer Ceramic Capacitor

A three-terminal multilayer ceramic capacitor according to an example embodiment of the present invention will be described.

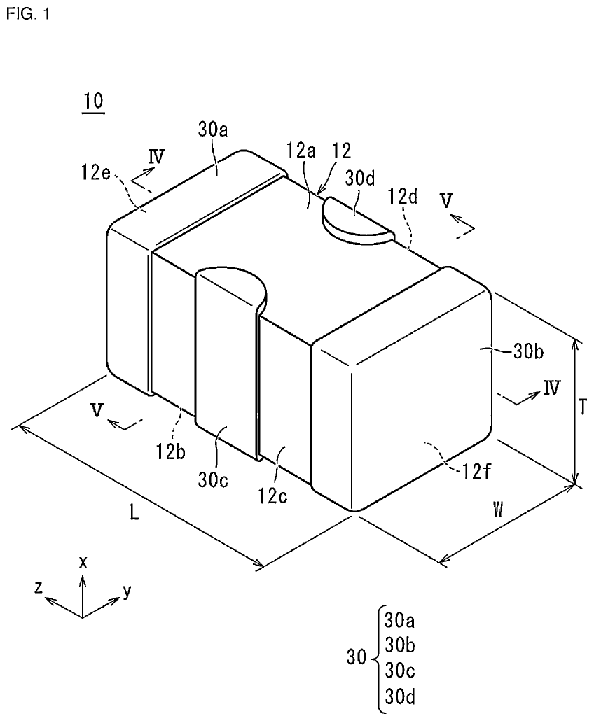

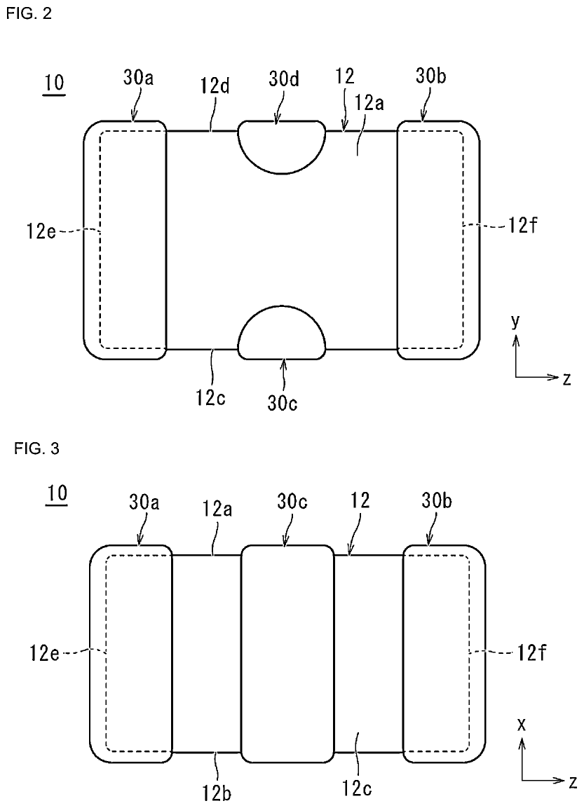

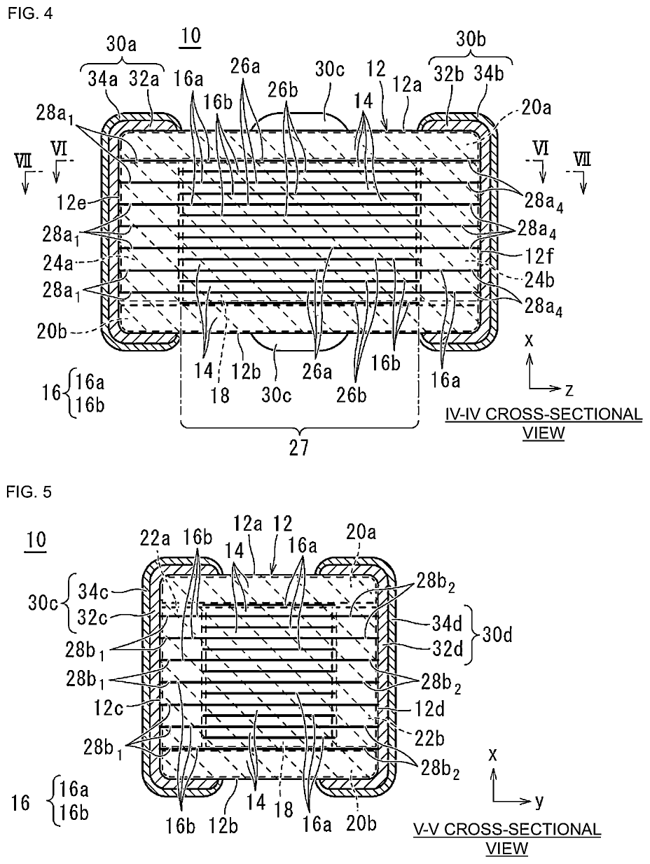

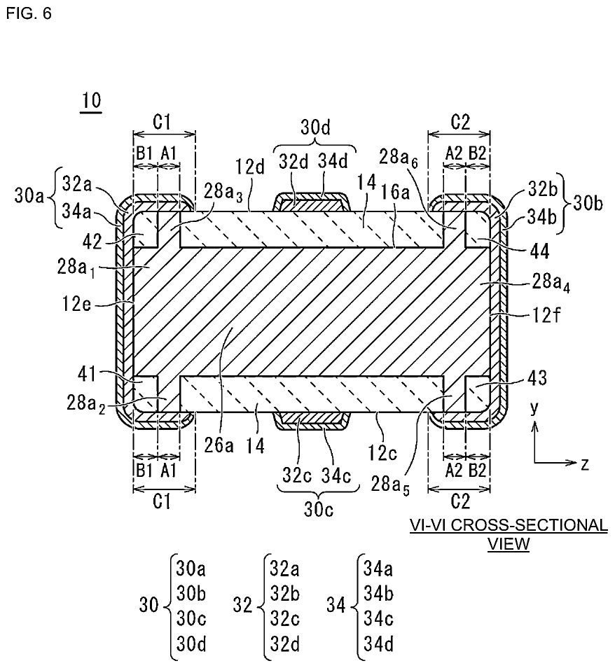

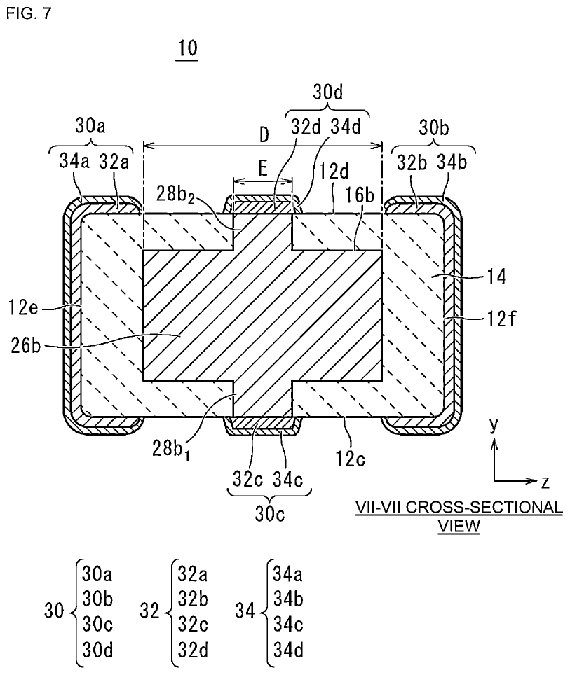

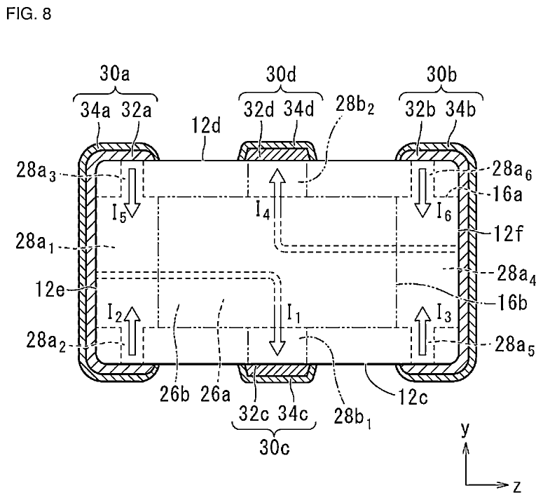

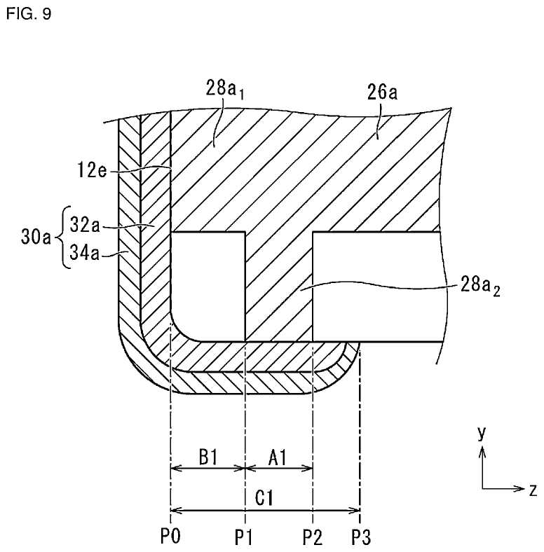

FIG. 1 is an external perspective view illustrating an example of the three-terminal multilayer ceramic capacitor according to the example embodiment of the present invention. FIG. 2 is a top view illustrating an example of the three-terminal multilayer ceramic capacitor according to the example embodiment of the present invention. FIG. 3 is a front view illustrating an example of the three-terminal multilayer ceramic capacitor according to the example embodiment of the present invention. FIG. 4 is a cross-sectional view taken along line IV-IV in FIG. 1. FIG. 5 is a cross-sectional view taken along line V-V in FIG. 1. FIG. 6 is a cross-sectional view taken along line VI-VI in FIG. 4. FIG. 7 is a cross-sectional view taken along line VII-VII in FIG. 4. FIG. 8 is a plan view illustrating current flows in the three-terminal multilayer ceramic capacitor in FIG. 1. FIG. 9 is a partially enlarged view of FIG. 6.

As illustrated in FIG. 1, a three-terminal multilayer ceramic capacitor 10 includes, for example, a rectangular or substantially rectangular parallelepiped multilayer body 12 and an outer electrode 30.

### (1) Multilayer Body

The multilayer body 12 includes a plurality of laminated dielectric layers 14 and a plurality of inner electrode layers 16 laminated on the dielectric layers 14. The dielectric layers 14 and the inner electrode layers 16 are laminated in a height direction x.

The multilayer body 12 includes a first main surface 12a and a second main surface 12b that face each other in the height direction x, a first side surface 12c and a second side surface 12d that face each other in a width direction y orthogonal or substantially orthogonal to the height direction x, and a first end surface 12e and a second end surface 12f that face each other in a length direction z orthogonal or substantially orthogonal to the height direction x and the width direction y. This multilayer body 12 includes rounded corners and ridges. The corners are where three adjacent faces of the multilayer body intersect, while the ridges are where two adjacent faces of the multilayer body intersect. Furthermore, for example, unevenness or the like may be provided on some or all of the first main surface 12a and the second main surface 12b, the first side surface 12c and the second side surface 12d, and the first end surface 12e and the second end surface 12f.

A dimension L of the multilayer body 12 in the length direction z is not necessarily longer than a dimension W in the width direction y.

The multilayer body 12 includes an inner layer portion 18, and a first main surface side outer layer portion 20a and a second main surface side outer layer portion 20b, which are disposed so as to sandwich the inner layer portion 18 in the lamination direction.

The inner layer portion 18 includes the plurality of dielectric layers 14 and the plurality of inner electrode layers 16. The inner layer portion 18 includes the inner electrode layers 16 from the one located closest to the first main surface 12a to the one located closest to the second main surface 12b in the lamination direction. The inner electrode layers 16 include a first inner electrode layer 16a extending to the first end surface 12e, the second end surface 12f, the first side surface 12c, and the second side surface 12d, and a second inner electrode layer 16b extending to the first side surface 12c and the second side surface 12d. In the inner layer portion 18, a plurality of the first inner electrode layers 16a and second inner electrode layers 16b face each other with the dielectric layers 14 interposed therebetween. The inner layer portion 18 generates electrostatic capacitance and substantially functions as a capacitor.

The first main surface side outer layer portion 20a is located on the first main surface 12a side, and includes a plurality of dielectric layers 14 located between the first main surface 12a, the outermost surface of the inner layer portion 18 on the first main surface 12a side, and a straight line on the outermost surface (an extension from the outermost surface to the first side surface 12c, the second side surface 12d, the first end surface 12e, and the second end surface 12f). In other words, the first main surface side outer layer portion 20a is an assembly of a plurality of dielectric layers 14 located between the first main surface 12a and the inner electrode layer 16 closest to the first main surface 12a. The dielectric layers 14 used for the first main surface side outer layer portion 20a may be the same as the dielectric layers 14 used for the inner layer portion 18.

Similarly, the second main surface side outer layer portion 20b is located on the second main surface 12b side, and includes a plurality of dielectric layers 14 located between the second main surface 12b, the outermost surface of the inner layer portion 18 on the second main surface 12b side, and a straight line on that outermost surface (an extension from the outermost surface to the first side surface 12c, the second side surface 12d, the first end surface 12e, and the second end surface 12f). In other words, the second main surface side outer layer portion 20b is an assembly of a plurality of dielectric layers 14 located between the second main surface 12b and the inner electrode layer 16 closest to the second main surface 12b. The dielectric layers 14 used for the second main surface side outer layer portion 20b may be the same as the dielectric layers 14 used for the inner layer portion 18.

The multilayer body 12 also includes a first side surface side outer layer portion 22a located on the first side surface 12c side and including a plurality of dielectric layers 14 located between the first side surface 12c and the outermost surface of the inner layer portion 18 on the first side surface 12c side.

Similarly, the multilayer body 12 includes a second side surface side outer layer portion 22b located on the second side surface 12d side and including a plurality of dielectric layers 14 located between the second side surface 12d and the outermost surface of the inner layer portion 18 on the second side surface 12d side.

The first side surface side outer layer portion 22a and the second side surface side outer layer portion 22b are also referred to as W gaps or side gaps.

The multilayer body 12 further includes a first end surface side outer layer portion 24a located on the first end surface 12e side and including a plurality of dielectric layers 14 located between the first end surface 12e and the outermost surface of the inner layer portion 18 on the first end surface 12e side.

Similarly, the multilayer body 12 includes a second end surface side outer layer portion 24b located on the second end surface 12f side and including a plurality of dielectric layers 14 located between the second end surface 12f and the outermost surface of the inner layer portion 18 on the second end surface 12f side.

The first end surface side outer layer portion 24a and the second end surface side outer layer portion 24b are also referred to as L gaps or end gaps.

The dimensions of the multilayer body 12 are not particularly limited.

The dielectric layer 14 can be made of a dielectric material, for example, a ceramic material. As such a dielectric material, for example, a dielectric ceramic including components such as BaTiO₃, CaTiO₃, SrTiO₃, or CaZrO₃ can be used. When the dielectric material is included as a main component, a subcomponent such as, for example, a Mn compound, a Fe compound, a Cr compound, a Co compound, or a Ni compound may be added in a smaller amount than the main component, depending on the desired characteristics of the multilayer body 12.

The dielectric layer 14 after firing preferably has a thickness of, for example, larger than or equal to about 0.5 μm and smaller than or equal to about 10.0 μm. The number of the dielectric layers 14 to be laminated is, for example, preferably larger than or equal to 15 and smaller than or equal to 600. The number of the dielectric layers 14 is the total number of the dielectric layers 14 in the inner layer portion 18 and the dielectric layers 14 in the first main surface side outer layer portion 20a and the second main surface side outer layer portion 20b.

The multilayer body 12 includes a plurality of first inner electrode layers 16a and a plurality of second inner electrode layers 16b as the plurality of inner electrode layers 16. The plurality of first inner electrode layers 16a are disposed on the plurality of dielectric layers 14 and extend to the first end surface 12e, the second end surface 12f, the first side surface 12c, and the second side surface 12d. The plurality of second inner electrode layers 16b are disposed on the plurality of dielectric layers 14 and extend to the first side surface 12c and the second side surface 12d.

The plurality of first inner electrode layers 16a and the plurality of second inner electrode layers 16b may be alternately laminated with the dielectric layers 14 interposed therebetween. Alternatively, a plurality of dielectric layers 14 on which the first inner electrode layers 16a are disposed may be laminated, and then dielectric layers 14 on which the second inner electrode layers 16b are disposed may be laminated. The lamination pattern can thus be changed according to the capacitance value to be realized.

As illustrated in FIG. 6, the first inner electrode layer 16a includes a first counter electrode portion 26a that faces the second inner electrode layer 16b, and first to sixth extended electrode portions 28a₁ to 28a₆. The first to third extended electrode portions 28a₁ to 28a₃ are connected to the first outer electrode 30a of the outer electrode 30. Here, the first outer electrode 30a is disposed on the first end surface 12e of the multilayer body 12, and extends from the first end surface 12e to be disposed on a portion of the first main surface 12a, a portion of the second main surface 12b, a portion of the first side surface 12c, and a portion of the second side surface 12d. The fourth and sixth extended electrode portions 28a₄ to 28a₆ are connected to the second outer electrode 30b of the outer electrode 30. Here, the second outer electrode 30b is disposed on the second end surface 12f of the multilayer body 12, and extends from the second end surface 12f to be disposed on a portion of the first main surface 12a, a portion of the second main surface 12b, a portion of the first side surface 12c, and a portion of the second side surface 12d. The first to sixth extended electrode portions 28a₁ to 28a₆ will be further described.

The first extended electrode portion 28a₁ extends in the length direction z from the first counter electrode portion 26a, to the surface of the first end surface 12e of the multilayer body 12, and is connected to the first outer electrode 30a. The second extended electrode portion 28a₂ extends in the width direction y from the first counter electrode portion 26a, to the surface of the first side surface 12c of the multilayer body 12 at a position spaced away from the first end surface 12e on the first end surface 12e side, and is connected to the first outer electrode 30a. The third extended electrode portion 28a₃ extends in the width direction y from the first counter electrode portion 26a, to the surface of the second side surface 12d of the multilayer body 12 at a position spaced away from the first end surface 12e on the first end surface 12e side, and is connected to the first outer electrode 30a. The second extended electrode portion 28a₂ may extend in the width direction y from the first extended electrode portion 28a₁, instead of from the first counter electrode portion 26a, and may extend to the surface of the first side surface 12c of the multilayer body 12 at a position spaced away from the first end surface 12e on the first end surface 12e side. Similarly, the third extended electrode portion 28a₃ may extend in the width direction y from the first extended electrode portion 28a₁, instead of from the first counter electrode portion 26a, and may extend to the surface of the second side surface 12d of the multilayer body 12 at a position spaced away from the first end surface 12e on the first end surface 12e side.

The fourth extended electrode portion 28a₄ extends in the length direction z from the first counter electrode portion 26a, to the surface of the second end surface 12f of the multilayer body 12, and is connected to the second outer electrode 30b. The fifth extended electrode portion 28a₅ extends in the width direction y from the first counter electrode portion 26a, to the surface of the first side surface 12c of the multilayer body 12 at a position spaced away from the second end surface 12f on the second end surface 12f side, and is connected to the second outer electrode 30b. The sixth extended electrode portion 28a₆ extends in the width direction y from the first counter electrode portion 26a, to the surface of the second side surface 12d of the multilayer body 12 at a position spaced away from the second end surface 12f on the second end surface 12f side, and is connected to the second outer electrode 30b. The fifth extended electrode portion 28a₅ may extend in the width direction y from the fourth extended electrode portion 28a₄, instead of from the first counter electrode portion 26a, and may extend to the surface of the first side surface 12c of the multilayer body 12 at a position spaced away from the second end surface 12f on the second end surface 12f side. Similarly, the sixth extended electrode portion 28a₆ may extend in the width direction y from the fourth extended electrode portion 28a₄, instead of from the first counter electrode portion 26a, and may extend to the surface of the second side surface 12d of the multilayer body 12 at a position spaced away from the second end surface 12f on the second end surface 12f side.

As described above, the first inner electrode layer 16a includes the second extended electrode portion 28a₅, the third extended electrode portion 28a₃, the fifth extended electrode portion 28a₅, and the sixth extended electrode portion 28a₆, in addition to the first extended electrode portion 28a₁ and the fourth extended electrode portion 28a4. Specifically, the first inner electrode layer 16a is exposed not only at the first end surface 12e and the second end surface 12f of the multilayer body 12, but also at the first side surface 12c and the second side surface 12d of the multilayer body 12. The first inner electrode layer 16a is not only connected to the first outer electrode 30a by the first extended electrode portion 28a₁ at the first end surface 12e of the multilayer body 12, but is connected to the first outer electrode 30a by the second extended electrode portion 28a₂ at the first side surface 12c of the multilayer body 12 and connected to the first outer electrode 30a by the third extended electrode portion 28a₃ at the second side surface 12d of the multilayer body 12. Furthermore, the first inner electrode layer 16a is not only connected to the second outer electrode 30b by the fourth extended electrode portion 28a₄ at the second end surface 12f of the multilayer body 12, but is connected to the second outer electrode 30b by the fifth extended electrode portion 28a₅ at the first side surface 12c of the multilayer body 12 and connected to the second outer electrode 30b by the sixth extended electrode portion 28a₆ at the second side surface 12d of the multilayer body 12. Therefore, the junction area between the first inner electrode layer 16a and the first outer electrode 30a and the second outer electrode 30b is larger than the junction area when the first inner electrode layer 16a is connected to the first outer electrode 30a and the second outer electrode 30b only by the first extended electrode portion 28a₁ and the fourth extended electrode portion 28a4. This makes it possible to reduce or prevent DC resistance in the first inner electrode layer 16a, thus reducing or preventing heat generation in the three-terminal multilayer ceramic capacitor 10.

The first inner electrode layer 16a is not exposed at a corner of the multilayer body 12. Specifically, the second extended electrode portion 28a₂ extends to the first side surface 12c at a position spaced away from the first end surface 12e. Therefore, the first inner electrode layer 16a is not exposed but the plurality of dielectric layers 14 are exposed at a first multilayer body corner portion 41 surrounded by the first extended electrode portion 28a₁ and the second extended electrode portion 28a₅ in top view. Similarly, the third extended electrode portion 28a₃ extends to the second side surface 12d at a position spaced away from the first end surface 12e. Therefore, the first inner electrode layer 16a is not exposed but the plurality of dielectric layers 14 are exposed at a second multilayer body corner portion 42 surrounded by the first extended electrode portion 28a₁ and the third extended electrode portion 28a₃ in top view. Moreover, the fifth extended electrode portion 28a₅ extends to the first side surface 12c at a position spaced away from the second end surface 12f. Therefore, the first inner electrode layer 16a is not exposed but the plurality of dielectric layers 14 are exposed at a third multilayer body corner portion 43 surrounded by the fourth extended electrode portion 28a₄ and the fifth extended electrode portion 28a₅ in top view. Similarly, the sixth extended electrode portion 28a₆ extends to the second side surface 12d at a position spaced away from the second end surface 12f. Therefore, the first inner electrode layer 16a is not exposed but the plurality of dielectric layers 14 are exposed at a fourth multilayer body corner portion 44 surrounded by the fourth extended electrode portion 28a₄ and the sixth extended electrode portion 28a₆ in top view.

Here, the first to fourth multilayer body corner portions 41 to 44 are corner portions of the multilayer body 12. Therefore, an underlying electrode layer 32 that defines the lower layer of the outer electrode 30 is not sufficiently provided on the surfaces of the first to fourth multilayer body corner portions 41 to 44 of the multilayer body 12, making it likely for the underlying electrode layer 32 to be thinner. When the underlying electrode layer 32 becomes thinner on the surfaces of the first to fourth multilayer body corner portions 41 to 44 and when the underlying electrode layer 32 becomes partially discontinuous due to the thinned underlying electrode layer 32, a plating solution and moisture for plating the underlying electrode layer 32 easily infiltrate from outside into the first to fourth multilayer body corner portions 41 to 44 and further into the inside of the multilayer body 12 through the first inner electrode layer 16a. According to the present example embodiment, the first inner electrode layer 16a is not exposed on the surfaces of the first to fourth multilayer body corner portions 41 to 44. Therefore, even if the plating solution and moisture infiltrate from outside through the first to fourth multilayer body corner portions 41 to 44, the plating solution and moisture can be reduced or prevented from infiltrating into the multilayer body 12 from the first to fourth multilayer body corner portions 41 to 44 through the first inner electrode layer 16a. This makes it possible to improve humidity resistance reliability of the three-terminal multilayer ceramic capacitor 10.

As illustrated in FIG. 8, the direction of a first current I₁ flowing from the first inner electrode layer 16a to the portion of the second inner electrode layer 16b exposed on the first side surface 12c (a seventh extended electrode portion 28b₁) is opposite to the direction of a second current I₂ flowing from the second extended electrode portion 28a₂ to the first extended electrode portion 28a₁ or the first counter electrode portion 26a, and the direction of a third current I₃ flowing from the fifth extended electrode portion 28a₅ to the fourth extended electrode portion 28a₄ or the first counter electrode portion 26a. Therefore, an inductance (L component) generated by a magnetic field generated by the first current I₁ and an inductance (L component) generated by a magnetic field generated by the second current I₂ and the third current I₃ cancel each other out. Furthermore, the direction of a fourth current I₄ flowing from the first inner electrode layer 16a to the portion of the second inner electrode layer 16b exposed on the second side surface 12d (an eighth extended electrode portion 28b₂) is opposite to the direction of a fifth current I₅ flowing from the third extended electrode portion 28a₃ to the first extended electrode portion 28a₁ or the first counter electrode portion 26a and the direction of a sixth current I₆ flowing from the sixth extended electrode portion 28a₆ to the fourth extended electrode portion 28a₄ or the first counter electrode portion 26a. Therefore, an inductance (L component) generated by a magnetic field generated by the fourth current I₄ and an inductance (L component) generated by a magnetic field generated by the fifth current I₅ and the sixth current I₆ cancel each other out. The inductance (L component) of the entire capacitor formed by the first inner electrode layer 16a and the second inner electrode layer 16b can thus be reduced or prevented, making it possible to obtain the three-terminal multilayer ceramic capacitor 10 with low ESL (equivalent series resistance) characteristics.

The shape of the first counter electrode portion 26a and the shape of the first to sixth extended electrode portions 28a₁ to 28a₆ are not particularly limited, but are, for example, preferably rectangular or substantially rectangular. However, the corners may be rounded.

The dimensions of the first extended electrode portion 28a₁ and the fourth extended electrode portion 28a₄ in the width direction y may be the same or substantially the same as or smaller than the dimension of the first counter electrode portion 26a in the width direction y.

The dimensions of the second, third, fifth, and sixth extended electrode portions 28a₂, 28a₃, 28a₅, and 28a₆ in the length direction z are preferably the same or substantially the same, but may be different. The dimensions of the second, third, fifth, and sixth extended electrode portions 28a₂, 28a₃, 28a₅, and 28a₆ in the width direction y are preferably the same or substantially the same, but may be different. It is also preferable that the dimensions of the second, third, fifth, and sixth extended electrode portions 28a₁ to 28a₆ in the length direction z are defined as follows.

As illustrated in FIG. 9, the dimension A1 (dimension from P1 to P2) in the length direction z of the second extended electrode portion 28a₂ and the third extended electrode portion 28a₃ is, for example, preferably about 20% to about 75% of the dimension C1 (dimension from P0 to P3) in the length direction z of the portion of the first outer electrode 30a disposed on a portion of the first main surface 12a and a portion of the second main surface 12b as well as a portion of the first side surface 12c and a portion of the second side surface 12d. This makes it possible to reduce or prevent the DC resistance in the first inner electrode layer 16a, thus reducing or preventing the heat generation in the three-terminal multilayer ceramic capacitor 10. The three-terminal multilayer ceramic capacitor 10 with excellent humidity resistance reliability can thus be obtained. This will be described more specifically below.

The dimension A1 in the length direction z of the second extended electrode portion 28a₂ and the third extended electrode portion 28a₃ is, for example, more than or equal to about 20% of the dimension C1 in the length direction z of the first outer electrode 30a. This makes it possible to ensure the junction area between the second and third extended electrode portions 28a₂ and 28a₃ and the first outer electrode 30a. Moreover, the continuity from the second and third extended electrode portions 28a₂ and 28a₃ to the first counter electrode portion 26a or the first extended electrode portion 28a₁ can be ensured. The junction strength between the first inner electrode layer 16a and the first outer electrode 30a can also be increased. This makes it possible to reduce or prevent the DC resistance in the first inner electrode layer 16a, thus reducing or preventing the heat generation in the three-terminal multilayer ceramic capacitor 10.

Furthermore, since the dimension A1 in the length direction z of the second and third extended electrode portions 28a₂ and 28a₃ is, for example, less than or equal to about 75% of the dimension C1 in the length direction z of the first outer electrode 30a, moisture does not easily reach the second and third extended electrode portions 28a₂ and 28a₃ from the end portions of the first outer electrode 30a (boundary portions between the first outer electrode 30a and the multilayer body 12 on the first main surface 12a, the second main surface 12b, the first side surface 12c, and the second side surface 12d). This makes it possible to improve the humidity resistance reliability of the three-terminal multilayer ceramic capacitor 10.

Furthermore, the dimension A2 in the length direction z of the fifth extended electrode portion 28a₅ and the sixth extended electrode portion 28a₆ is, for example, preferably about 20% to about 75% of the dimension C2 in the length direction z of the portion of the second outer electrode 30b disposed on a portion of the first main surface 12a and a portion of the second main surface 12b as well as a portion of the first side surface 12c and a portion of the second side surface 12d. This makes it possible, as described above, to reduce or prevent the DC resistance in the first inner electrode layer 16a, thus reducing or preventing the heat generation in the three-terminal multilayer ceramic capacitor 10. The three-terminal multilayer ceramic capacitor 10 with excellent humidity resistance reliability can thus be obtained. This will be described more specifically below.

The dimension A2 in the length direction z of the fifth extended electrode portion 28a₅ and the sixth extended electrode portion 28a₆ is, for example, more than or equal to about 20% of the dimension C2 in the length direction z of the second outer electrode 30b. This makes it possible to ensure the junction area between the fifth and sixth extended electrode portions 28a₅ and 28a₆ and the second outer electrode 30b. Moreover, the continuity from the fifth and sixth extended electrode portions 28a₅ and 28a₆ to the first counter electrode portion 26a or the first extended electrode portion 28a₁ can be ensured. The junction strength between the first inner electrode layer 16a and the second outer electrode 30b can also be increased. This makes it possible to reduce or prevent the DC resistance in the first inner electrode layer 16a, thus reducing or preventing the heat generation in the three-terminal multilayer ceramic capacitor 10.

Furthermore, since the dimension A2 in the length direction z of the fifth and sixth extended electrode portions 28a₅ and 28a₆ is, for example, less than or equal to about 75% of the dimension C2 in the length direction z of the second outer electrode 30b, moisture does not easily reach the fifth and sixth extended electrode portions 28a₅ and 28a₆ from the end portions of the second outer electrode 30b (boundary portions between the second outer electrode 30b and the multilayer body 12 on the first main surface 12a, the second main surface 12b, the first side surface 12c, and the second side surface 12d). This makes it possible to improve the humidity resistance reliability of the three-terminal multilayer ceramic capacitor 10.

Here, the dimension A1 in the length direction z of the second and third extended electrode portions 28a₂ and 28a₃ is measured as follows, for example. First, the three-terminal multilayer ceramic capacitor 10 is polished up to about 1/2T in the height direction x so that the polished surface is approximately parallel to the first main surface 12a. The first inner electrode layer 16a is thus exposed. Next, the dimension A1 in the length direction z of the second extended electrode portion 28a₂ exposed on the surface of the multilayer body 12 at the first side surface 12c and the dimension A1 in the length direction z of the third extended electrode portion 28a₃ exposed on the surface of the multilayer body 12 at the second side surface 12d are each measured using a microscope. The average value of these measurements is then set as the dimension A1 in the length direction z of the second extended electrode portion 28a₂ and the third extended electrode portion 28a₃.

The dimension A2 in the length direction z of the fifth extended electrode portion 28a₅ and the sixth extended electrode portion 28a₆ is measured as follows, for example. The dimension A2 in the length direction z of the fifth extended electrode portion 28a₅ exposed on the surface of the multilayer body 12 at the first side surface 12c on the polished surface as described above, and the dimension A2 in the length direction z of the sixth extended electrode portion 28a₆ exposed on the surface of the multilayer body 12 at the second side surface 12d are each measured using a microscope. The average value of these measurements is set as the dimension A2 in the length direction z of the fifth extended electrode portion 28a₅ and the sixth extended electrode portion 28a₆.

The dimension C1 in the length direction z of the portion of the first outer electrode 30a disposed on a portion of the first main surface 12a and a portion of the second main surface 12b as well as a portion of the first side surface 12c and a portion of the second side surface 12d is measured as follows, for example.

As described above, the three-terminal multilayer ceramic capacitor 10 is polished up to about 1/2T in the height direction x. Next, the dimension C1 of the first outer electrode 30a disposed on a portion of the first side surface 12c and a portion of the second side surface 12d of the multilayer body 12 (this dimension C1 does not include the dimension of the first outer electrode 30a disposed on the first end surface 12e) is measured using a microscope. The average value of these measurements is set as the dimension C1.

Furthermore, on the polished surface as described above, the dimension C2 of the second outer electrode 30b disposed on a portion of the first side surface 12c and a portion of the second side surface 12d of the multilayer body 12 (this dimension C2 does not include the dimension of the second outer electrode 30b disposed on the second end surface 12f) is measured using a microscope. The average value of these measurements is set as the dimension C2 in the length direction z of the portion of the second outer electrode 30b disposed on a portion of the first main surface 12a and a portion of the second main surface 12b as well as a portion of the first side surface 12c and a portion of the second side surface 12d.

As illustrated in FIG. 9, the dimension B1 (dimension from P0 to P1) in the length direction z from the first end surface 12e to the side of the second extended electrode portion 28a₂ on the first end surface 12e side and from the first end surface 12e to the side of the third extended electrode portion 28a₃ on the first end surface 12e side is, for example, preferably about 25% to about 80% of the dimension C1 (dimension from P0 to P3) in the length direction z of the portion of the first outer electrode 30a disposed on a portion of the first main surface 12a and a portion of the second main surface 12b as well as a portion of the first side surface 12c and a portion of the second side surface 12d. This makes it possible to improve the excellent humidity resistance reliability and reduce or prevent the DC resistance in the first inner electrode layer 16a, thus reducing or preventing the heat generation of the three-terminal multilayer ceramic capacitor 10. This will be described more specifically below.

The dimension B1 in the length direction z from the first end surface 12e to the side of the second extended electrode portion 28a₂ on the first end surface 12e side and from the first end surface 12e to the side of the third extended electrode portion 28a₃ on the first end surface 12e side is, for example, more than or equal to 25% of the dimension C1 in the length direction z of the first outer electrode 30a. This reduces or prevents moisture infiltrated from the first end surface 12e from easily reaching the second extended electrode portion 28a₂ and the third extended electrode portion 28a₃. This makes it possible to reduce or prevent moisture infiltration into the multilayer body 12 through the second extended electrode portion 28a₂ and the third extended electrode portion 28a₃, thus improving the humidity resistance reliability of the three-terminal multilayer ceramic capacitor 10. For example, as described above, when the underlying electrode layer 32 is thinned at the first and second multilayer body corner portions 41 and 42, or when the underlying electrode layer 32 becomes discontinuous, the plating solution and moisture easily infiltrate into the first and second multilayer body corner portions 41 and 42 from outside. Even in such a case, the humidity resistance reliability can be improved by adjusting the dimensions as described above.

Furthermore, the dimension B1 in the length direction z from the first end surface 12e to the side of the second extended electrode portion 28a₂ on the first end surface 12e side and from the first end surface 12e to the side of the third extended electrode portion 28a₃ on the first end surface 12e side is, for example, less than or equal to 80% of the dimension C1 in the length direction z of the first outer electrode 30a. This makes it possible to ensure the junction area between the first outer electrode 30a and the first inner electrode layer 16a. Therefore, the DC resistance in the first inner electrode layer 16a can be reduced or prevented, thus reducing or preventing the heat generation of the three-terminal multilayer ceramic capacitor 10.

Furthermore, the dimension B2 in the length direction z from the second end surface 12f to the side of the fifth extended electrode portion 28a₅ on the second end surface 12f side and from the second end surface 12f to the side of the sixth extended electrode portion 28a₆ on the second end surface 12f side is, for example, preferably about 25% to about 80% of the dimension C2 in the length direction z of the portion of the second outer electrode 30b disposed on a portion of the first main surface 12a and a portion of the second main surface 12b as well as a portion of the first side surface 12c and a portion of the second side surface 12d. This makes it possible to improve the excellent humidity resistance reliability and reduce or prevent the DC resistance in the first inner electrode layer 16a, thus reducing or preventing the heat generation in the three-terminal multilayer ceramic capacitor 10. This will be described more specifically below.

The dimension B2 in the length direction z from the second end surface 12f to the side of the fifth extended electrode portion 28a₅ on the second end surface 12f side and from the second end surface 12f to the side of the sixth extended electrode portion 28a₆ on the second end surface 12f side is, for example, more than or equal to about 25% of the dimension C2 in the length direction z of the second outer electrode 30b. This reduces or prevents moisture infiltrated from the second end surface 12f from easily reaching the fifth extended electrode portion 28a₅ and the sixth extended electrode portion 28a₆. This makes it possible to reduce or prevent moisture infiltration into the multilayer body 12 through the fifth extended electrode portion 28a₅ and the sixth extended electrode portion 28a₆, thus improving the humidity resistance reliability of the three-terminal multilayer ceramic capacitor 10. For example, as described above, when the underlying electrode layer 32 is thinned at the third and fourth multilayer body corner portions 43 and 44, or when the underlying electrode layer 32 becomes discontinuous, the plating solution and moisture easily infiltrate into the third and fourth multilayer body corner portions 43 and 44 from outside. Even in such a case, the humidity resistance reliability can be improved by adjusting the dimensions as described above.

Moreover, the dimension B2 in the length direction z from the second end surface 12f to the side of the fifth extended electrode portion 28a₅ on the second end surface 12f side and from the second end surface 12f to the side of the sixth extended electrode portion 28a₆ on the second end surface 12f side is, for example, less than or equal to 80% of the dimension C2 in the length direction z of the second outer electrode 30b. This makes it possible to ensure the junction area between the second outer electrode 30b and the first inner electrode layer 16a. Therefore, the DC resistance in the first inner electrode layer 16a can be reduced or prevented, thus reducing or preventing the heat generation of the three-terminal multilayer ceramic capacitor 10.

The dimension B1 in the length direction z from the first end surface 12e to the side of the second extended electrode portion 28a₂ on the first end surface 12e side and from the first end surface 12e to the side of the third extended electrode portion 28a₃ on the first end surface 12e side is determined as follows, for example. Specifically, the dimensions B1 in the length direction z from the first end surface 12e (position P0) to the side of the second extended electrode portion 28a₂ on the first end surface 12e side (position P1) and from the first end surface 12e to the side of the third extended electrode portion 28a₃ on the first end surface 12e side (position P1) are measured using a microscope on the polished surface as described above, and the average value is calculated.

The dimension B2 in the length direction z from the second end surface 12f to the side of the fifth extended electrode portion 28a₅ on the second end surface 12f side and from the second end surface 12f to the side of the sixth extended electrode portion 28a₆ on the second end surface 12f side is determined as follows, for example. Specifically, the dimensions B2 in the length direction z from the second end surface 12f to the side of the fifth extended electrode portion 28a₅ on the second end surface 12f side and from the second end surface 12f to the side of the sixth extended electrode portion 28a₆ on the second end surface 12f side are measured using a microscope on the polished surface as described above, and the average value is calculated.

The first to sixth extended electrode portions 28a₁ to 28a₆ may have, for example, a rectangular or substantially rectangular shape or a tapered shape.

As illustrated in FIG. 7, the second inner electrode layer 16b has a cross shape substantially cross shape and includes a second counter electrode portion 26b that faces the first counter electrode portion 26a of the first inner electrode layer 16a, the seventh extended electrode portion 28b1 that extends from the second counter electrode portion 26b in the width direction y and to the surface of the first side surface 12c of the multilayer body 12, and an eighth extended electrode portion 28b2 extending from the second counter electrode portion 26b to the surface of the second side surface 12d of the multilayer body 12. Specifically, the seventh extended electrode portion 28b₁ is exposed to the surface of the first side surface 12c of the multilayer body 12, while the eighth extended electrode portion 28b₂ is exposed to the surface of the second side surface 12d of the multilayer body 12. Therefore, the second inner electrode layer 16b is not exposed to the surface of the first end surface 12e and the surface of the second end surface 12f of the multilayer body 12.

The shape of the second counter electrode portion 26b and the shape of the seventh extended electrode portion 28b₁ and the eighth extended electrode portion 28b₂ are, for example, preferably rectangular or substantially rectangular. However, the corners may be rounded.

The relationship between the dimension D in the length direction z connecting the side of the second counter electrode portion 26b on the first end surface 12e side and the side thereof on the second end surface 12f side and the dimension E in the length direction z connecting the sides of the seventh extended electrode portion 28b₁ and the eighth extended electrode portion 28b₂ on the first end surface 12e side and the sides thereof on the second end surface 12f side is preferably D≥E.

The seventh extended electrode portion 28b₁ may have a tapered shape that is narrower toward the first side surface 12c. The eighth extended electrode portion 28b₂ may have a tapered shape that is narrower toward the second side surface 12d.

The dimension E in the length direction z of the seventh extended electrode portion 28b₁ and the eighth extended electrode portion 28b₂ is, for example, preferably about 100 μm to about 400 μm.

The multilayer body 12 includes a counter electrode portion 27. The counter electrode portion 27 is a portion where the first counter electrode portion 26a of the first inner electrode layer 16a and the second counter electrode portion 26b of the second inner electrode layer 16b face each other. The counter electrode portion 27 is configured as a portion of the inner layer portion 18. The counter electrode portion 27 is also referred to as an effective capacitor portion.

The first inner electrode layer 16a and the second inner electrode layer 16b can be made of an appropriate conductive material such as, for example, metals including Ni, Cu, Ag, Pd, and Au, or an alloy including at least one of these metals, such as an Ag-Pd alloy.

It is preferable that the total number of the first inner electrode layers 16a and second inner electrode layers 16b is, for example, 15 to 500.

It is preferable that the first inner electrode layer 16a has a thickness of, for example, about 0.5 μm to about 1.0 μm.

It is preferable that the second inner electrode layer 16b has a thickness of, for example, about 0.5 μm to about 1.0 μm.

### (2) Outer Electrode

The outer electrode 30 is disposed on the first end surface 12e side and the second end surface 12f side, the first side surface 12c side and the second side surface 12d side, and the first main surface 12a and the second main surface 12b of the multilayer body 12.

The outer electrode 30 includes a first outer electrode 30a, a second outer electrode 30b, a third outer electrode 30c, and a fourth outer electrode 30d.

The first outer electrode 30a is connected to the first inner electrode layer 16a and disposed on the first end surface 12e. The first outer electrode 30a also extends from the first end surface 12e of the multilayer body 12 and is disposed on a portion of the first main surface 12a and a portion of the second main surface 12b as well as a portion of the first side surface 12c and a portion of the second side surface 12d. In this case, the first outer electrode 30a is electrically connected to the first extended electrode portion 28a₁, the second extended electrode portion 28a₂, and the third extended electrode portion 28a₃ of the first inner electrode layer 16a.

The second outer electrode 30b is connected to the first inner electrode layer 16a and is disposed on the second end surface 12f. The second outer electrode 30b also extends from the second end surface 12f of the multilayer body 12 and is disposed on a portion of the first main surface 12a and a portion of the second main surface 12b as well as a portion of the first side surface 12c and a portion of the second side surface 12d. In this case, the second outer electrode 30b is electrically connected to the fourth extended electrode portion 28a₄, the fifth extended electrode portion 28a₅, and the sixth extended electrode portion 28a₆ of the first inner electrode layer 16a.

The third outer electrode 30c is connected to the second inner electrode layer 16b and is disposed on the first side surface 12c. The third outer electrode 30c also extends from the first side surface 12c of the multilayer body 12 and is disposed on a portion of the first main surface 12a and a portion of the second main surface 12b. In this case, the third outer electrode 30c is electrically connected to the seventh extended electrode portion 28b₁ of the second inner electrode layer 16b. The third outer electrode 30c may be disposed only on the first side surface 12c.

The fourth outer electrode 30d is connected to the second inner electrode layer 16b and is disposed on the second side surface 12d. The fourth outer electrode 30d also extends from the second side surface 12d of the multilayer body 12 and is disposed on a portion of the first main surface 12a and a portion of the second main surface 12b. In this case, the fourth outer electrode 30d is electrically connected to the eighth extended electrode portion 28b₂ of the second inner electrode layer 16b. The fourth outer electrode 30d may be disposed only on the second side surface 12d.

In the multilayer body 12, the first counter electrode portion 26a of the first inner electrode layer 16a and the second counter electrode portion 26b of the second inner electrode layer 16b face each other with the dielectric layer 14 interposed therebetween, thus generating an electrostatic capacitance. Therefore, the electrostatic capacitance can be obtained between the first and second outer electrodes 30a and 30b connected to the first inner electrode layer 16a and between the third and fourth outer electrodes 30c and 30d connected to the second inner electrode layer 16b, thus providing the characteristics of the capacitor.

The outer electrode 30 includes the underlying electrode layer 32 including a metal component and a glass component, and a plating layer 34 disposed on the surface of the underlying electrode layer 32.

The underlying electrode layer 32 includes a first underlying electrode layer 32a, a second underlying electrode layer 32b, a third underlying electrode layer 32c, and a fourth underlying electrode layer 32d.

The first underlying electrode layer 32a is connected to the first inner electrode layer 16a and disposed on the first end surface 12e. The first underlying electrode layer 32a also extends from the first end surface 12e and is disposed on a portion of the first main surface 12a and a portion of the second main surface 12b as well as a portion of the first side surface 12c and a portion of the second side surface 12d. In this case, the first underlying electrode layer 32a is electrically connected to the first extended electrode portion 28a₁, the second extended electrode portion 28a₂, and the third extended electrode portion 28a₃ of the first inner electrode layer 16a.

The second underlying electrode layer 32b is connected to the first inner electrode layer 16a and is disposed on the second end surface 12f. The second underlying electrode layer 32b also extends from the second end surface 12f and is also disposed on a portion of the first main surface 12a and a portion of the second main surface 12b as well as a portion of the first side surface 12c and a portion of the second side surface 12d. In this case, the second underlying electrode layer 32b is electrically connected to the fourth extended electrode portion 28a₄, the fifth extended electrode portion 28a₅, and the sixth extended electrode portion 28a₆ of the first inner electrode layer 16a.

The third underlying electrode layer 32c is connected to the second inner electrode layer 16b and is disposed on the first side surface 12c. The third underlying electrode layer 32c also extends from the first side surface 12c and is also disposed on a portion of the first main surface 12a and a portion of the second main surface 12b. In this case, the third underlying electrode layer 32c is electrically connected to the seventh extended electrode portion 28b₁ of the second inner electrode layer 16b. The third underlying electrode layer 32c may be disposed only on the first side surface 12c.

The fourth underlying electrode layer 32d is connected to the second inner electrode layer 16b and is disposed on the second side surface 12d. The fourth underlying electrode layer 32d also extends from the second side surface 12d and is also disposed on a portion of the first main surface 12a and a portion of the second main surface 12b. In this case, the fourth underlying electrode layer 32d is electrically connected to the eighth extended electrode portion 28b₂ of the second inner electrode layer 16b. The fourth underlying electrode layer 32d may be disposed only on the second side surface 12d.

The underlying electrode layer 32 includes, for example, at least one of a baked layer, a conductive resin layer, a thin film layer, and the like. In experimental examples to be described later, the underlying electrode layer 32 is a baked layer.

Each of the configurations where the underlying electrode layer 32 is the baked layer, the conductive resin layer, or the thin film layer will be described below.

### Underlying Electrode Layer is Baked Layer

The baked layer includes a glass component and a metal component. The glass component of the baked layer includes, for example, at least one of B, Si, Ba, Mg, Al, Li, and the like. The metal component of the baked layer includes at least one of, for example, Cu, Ni, Ag, Pd, Ag-Pd alloy, Au, and the like. The baked layer is formed by, for example, applying and baking a conductive paste including a glass component and a metal component to the multilayer body 12. The baked layer may be formed by, for example, simultaneously firing a multilayer chip having the inner electrode layer 16 and the dielectric layer 14 and a conductive paste applied to the multilayer chip, or may be formed by, for example, firing a multilayer chip having the inner electrode layer 16 and the dielectric layer 14 to obtain the multilayer body 12 and then baking a conductive paste to the multilayer body 12. In the case of forming the baked layer by simultaneously firing the multilayer chip having the inner electrode layer 16 and the dielectric layer 14 and the conductive paste applied to the multilayer chip, it is preferable that the baked layer is formed by baking a material to which a dielectric material is added instead of a glass component. The baked layer may be more than one layer.

The underlying electrode layer 32 including a dielectric material instead of the glass component can improve the close contact between the multilayer body 12 and the underlying electrode layer 32. The underlying electrode layer 32 may include both the glass component and the dielectric component.

The dielectric material included in the underlying electrode layer 32 may be the same type of dielectric material as that of the dielectric layer 14, or a different type of dielectric material. The dielectric component includes at least one of BaTiO₃, CaTiO₃, (Ba, Ca)TiO₃, SrTiO₃, CaZrO₃, and the like, for example.

When the first underlying electrode layer 32a is formed of a baked layer, the thickness in the length direction z at the center in the height direction x of the first underlying electrode layer 32a located on the first end surface 12e is preferably, for example, about 3 μm to about 20 μm.

Similarly, when the second underlying electrode layer 32b is formed of a baked layer, the thickness in the length direction z at the center in the height direction x of the second underlying electrode layer 32b located on the second end surface 12f is preferably, for example, about 3 μm to about 20 μm.

When a baked layer is provided as the underlying electrode layer 32 on the first main surface 12a and the second main surface 12b, the thickness in the height direction X connecting the first main surface 12a and the second main surface 12b at the center in the length direction z of the first underlying electrode layer 32a located on the first main surface 12a and the second main surface 12b is preferably, for example, about 3 μm to about 20 μm (thickness of the underlying electrode layer at the e-dimension center portion). Similarly, the thickness in the height direction x connecting the first main surface 12a and the second main surface 12b at the center in the length direction z of the second underlying electrode layer 32b located on the first main surface 12a and the second main surface 12b is preferably, for example, about 3 μm to about 20 μm (thickness of the underlying electrode layer at the e-dimension center portion).

Furthermore, when the underlying electrode layer 32 is provided as a baked layer on the first side surface 12c and the second side surface 12d, the thickness in the width direction y connecting the first side surface 12c and the second side surface 12d at the center in the length direction z of the first underlying electrode layer 32a located on the first side surface 12c and the second side surface 12d is preferably, for example, about 3 μm to about 70 μm (thickness of the underlying electrode layer at the center portion of the end surface). Similarly, the thickness in the width direction y connecting the first side surface 12c and the second side surface 12d at the center in the length direction z of the second underlying electrode layer 32b located on the first side surface 12c and the second side surface 12d is preferably, for example, about 3 μm to about 70 μm (thickness of the underlying electrode layer at the center portion of the end surface).

### Underlying Electrode Layer is Conductive Resin Layer

When a conductive resin layer is provided as the underlying electrode layer 32, the conductive resin layer may be disposed on the baked layer so as to cover the baked layer, or may be disposed directly on the multilayer body 12 without providing a baked layer.

The conductive resin layer includes metal such as, for example, conductive particles and a thermosetting resin.

The conductive resin layer may completely cover the underlying electrode layer, or may partially cover the underlying electrode layer.

Since the conductive resin layer includes the thermosetting resin, the conductive resin layer is more flexible than, for example, a plating film and a conductive layer made of a fired product of a conductive paste. Therefore, even when a physical impact or impact due to thermal cycles is applied to the three-terminal multilayer ceramic capacitor 10, the conductive resin layer defines and functions as a buffer layer to prevent cracks from occurring in the three-terminal multilayer ceramic capacitor 10.

The metal included in the conductive resin layer can be, for example, Ag, Cu, Ni, Sn, Bi or an alloy including these metals.

It is also possible to use a metal powder whose surface is coated with Ag, for example. When using a metal powder whose surface is coated with Ag, for example, it is preferable to use Cu, Ni, Sn, Bi, or an alloy powder of these metals as the metal powder. The reason for using Ag conductive metal powder as the conductive metal is that Ag has the lowest resistivity among metals and is therefore suitable as an electrode material. Furthermore, Ag is a precious metal and therefore does not oxidize and has high weather resistance. Ag also makes it possible to use a cheaper base metal while maintaining the characteristics of Ag described above.

Alternatively, for example, it is also possible to use Cu or Ni that has been subjected to antioxidation treatment as the metal included in the conductive resin layer.

It is also possible to use a metal powder whose surface is coated with, for example, Sn, Ni or Cu, as the metal included in the conductive resin layer. When using a metal powder whose surface is coated with Sn, Ni or Cu, for example, it is preferable to use Ag, Cu, Ni, Sn, Bi or an alloy powder of these metals as the metal powder.

The metal included in the conductive resin layer is mainly responsible for the electrical conductivity of the conductive resin layer. Specifically, contact between conductive fillers provides an electrical path inside the conductive resin layer.

The metal included in the conductive resin layer can be spherical or flat, but it is preferable to use a mixture of a spherical metal powder and a flat metal powder.

Examples of the resin included in the conductive resin layer include various known thermosetting resins such as an epoxy resin, a phenol resin, a urethane resin, a silicone resin, and a polyimide resin. In particular, the epoxy resin is excellent in heat resistance, humidity resistance, and adhesion and is one of the most preferable resins.

The conductive resin layer preferably includes a curing agent in addition to the thermosetting resin. For example, in the case of using the epoxy resin as a base resin, various known compounds such as phenols, amines, acid anhydrides, imidazoles, active esters, and amide-imides, for example, may be used as a curing agent for the epoxy resin.

The conductive resin layer may include more than one layer.

The conductive resin layer located at the center of the multilayer body 12 in the height direction x on the first end surface 12e and the second end surface 12f preferably has a thickness of, for example, about 10 μm to about 150 μm. The conductive resin layer at the center in the length direction z of the conductive resin layer located on the first main surface 12a, the second main surface 12b, the first side surface 12c, and the second side surface 12d preferably has a thickness of, for example, about 10 μm to about 150 μm.

### Underlying Electrode Layer is Thin Film Layer

When a thin film layer is provided as the underlying electrode layer 32, the thin film layer is formed by a thin film formation method such as, for example, sputtering or vapor deposition, and is a layer of, for example, about 1 μm or less formed by depositing metal particles.

The plating layer 34 includes a first plating layer 34a, a second plating layer 34b, a third plating layer 34c, and a fourth plating layer 34d.

The first plating layer 34a, the second plating layer 34b, the third plating layer 34c, and the fourth plating layer 34d, as the plating layer 34 that can be disposed on the underlying electrode layer 32, will be described with reference to FIGS. 4 and 5.

The first plating layer 34a, the second plating layer 34b, the third plating layer 34c, and the fourth plating layer 34d include, for example, at least of Cu, Ni, Sn, Ag, Pd, an Ag-Pd alloy, and Au.

The first plating layer 34a is disposed so as to cover the first underlying electrode layer 32a.

The second plating layer 34b is disposed so as to cover the second underlying electrode layer 32b.

The third plating layer 34c is disposed so as to cover the third underlying electrode layer 32c.

The fourth plating layer 34d is disposed so as to cover the fourth underlying electrode layer 32d.

The first plating layer 34a, the second plating layer 34b, the third plating layer 34c, and the fourth plating layer 34d may each include a plurality of layers. In this case, for example, the plating layer 34 preferably has a two-layer structure including a lower plating layer made of Ni plating formed on the underlying electrode layer 32, and an upper plating layer made of Sn plating formed on the lower plating layer.

More specifically, the first plating layer 34a includes a first lower plating layer and a first upper plating layer located on the surface of the first lower plating layer.

The second plating layer 34b includes a second lower plating layer and a second upper plating layer located on the surface of the second lower plating layer.

Similarly, the third plating layer 34c includes a third lower plating layer and a third upper plating layer located on the surface of the third lower plating layer.

The fourth plating layer 34d includes a fourth lower layer plating layer and a fourth upper layer plating layer located on the surface of the fourth lower layer plating layer.

The lower plating layer made of Ni plating prevents the underlying electrode layer 32 from being eroded by solder used to mount the three-terminal multilayer ceramic capacitor 10. The upper plating layer made of Sn plating increases the wettability of the solder used to mount the three-terminal multilayer ceramic capacitor 10, thus enabling the three-terminal multilayer ceramic capacitor 10 to be easily mounted.

Each plating layer preferably has, for example, a thickness of about 2.0 μm to about 15.0 μm.

### (3) Dimensions of Three-Terminal Multilayer Ceramic Capacitor

L dimension is the dimension in the length direction z of the three-terminal multilayer ceramic capacitor 10 including the multilayer body 12 and the first to fourth outer electrodes 30a to 30d. T dimension is the dimension in the height direction x of the three-terminal multilayer ceramic capacitor 10 including the multilayer body 12 and the first to fourth outer electrodes 30a to 30d. W dimension is the dimension in the width direction y of the three-terminal multilayer ceramic capacitor 10 including the multilayer body 12 and the first to fourth outer electrodes 30a to 30d.

Although the dimensions of the three-terminal multilayer ceramic capacitor 10 are not particularly limited, for example, the L dimension in the length direction z is about 1.0 mm to about 3.2 mm, the T dimension in the height direction x is about 0.3 mm to about 2.5 mm, and the W dimension in the width direction y is about 0.5 mm to about 2.5 mm. The dimensions of the three-terminal multilayer ceramic capacitor 10 can be measured using a microscope.

The three-terminal multilayer ceramic capacitor 10 illustrated in FIG. 1 has the above configuration to make it possible to reduce or prevent the DC resistance in the first inner electrode layer 16a and reduce or prevent heat generation in the three-terminal multilayer ceramic capacitor 10. The three-terminal multilayer ceramic capacitor 10 with excellent humidity resistance reliability and low ESL characteristics can thus be obtained.

### 2. Method for Manufacturing Three-Terminal Multilayer Ceramic Capacitor

Next, an example of a method for manufacturing a three-terminal multilayer ceramic capacitor will be described.

First, a dielectric sheet for a dielectric layer and a conductive paste for an inner electrode layer are prepared. The dielectric sheet and the conductive paste for the inner electrode layer contain a binder and a solvent. The binder and the solvent may be any known binder and solvent.

Then, the conductive paste for the inner electrode layer is printed in a predetermined pattern on the dielectric sheet, for example, by screen printing or gravure printing. As a result, a dielectric sheet on which the pattern of the first inner electrode layer is formed and a dielectric sheet on which the pattern of the second inner electrode layer is formed are prepared. More specifically, a screen plate for printing the first inner electrode layer and a screen plate for printing the second inner electrode layer are prepared separately, and a printer capable of printing with two types of screen plates separately can be used to print the pattern of each inner electrode layer. Here, the widths of the first to sixth extended electrode portions 28a₁ to 28a₆ and the seventh and eighth extended electrode portions 28b₁ and 28₂ on the screen plate are controlled during the design of the screen plate, so that extended electrode portions of a desired pattern can be obtained. In the experimental examples to be described later, the extended electrode portions are printed by gravure printing.

Subsequently, a predetermined number of dielectric sheets for an outer layer, on which no pattern of the inner electrode layer is printed, are laminated to form a portion to serve as a second main surface side outer layer portion on the second main surface side. Then, a dielectric sheet on which the pattern of the first inner electrode layer is printed and a dielectric sheet on which the pattern of the second inner electrode layer is printed are sequentially laminated on the portion to serve as the second main surface side outer layer portion so as to form the structure of the present invention, thereby forming a portion to serve as an inner layer portion. A predetermined number of dielectric sheets for the outer layer, on which no pattern of the inner electrode layer is printed, are laminated on the portion to serve as the inner layer portion, thus forming a portion to serve as the first main surface side outer layer portion on the first main surface side. A multilayer sheet is thus prepared. Then, the multilayer sheet is pressed in the lamination direction by, for example, an isostatic press or the like to produce a multilayer block.

Then, the multilayer block is cut to a predetermined size to obtain multilayer chips. In this event, the corners and ridges of the multilayer chips may be rounded by, for example, barrel polishing or the like.

Then, the multilayer chips thus cut out are fired to produce a multilayer body. The firing temperature is, for example, preferably about 900° C. to about 1400° C., depending on the materials of the dielectric layer and the inner electrode layer.

Next, the third underlying electrode layer 32c of the third outer electrode 30c is formed on the first side surface 12c of the fired multilayer body 12. The fourth underlying electrode layer 32d of the fourth outer electrode 30d is also formed on the second side surface 12d of the multilayer body 12.

### Underlying Electrode Layer is Baked Layer

When forming baked layers as the third underlying electrode layer 32c and the fourth underlying electrode layer 32d, a conductive paste including a glass component and a metal component is applied, followed by baking, to form the underlying electrode layers. The baking temperature is, for example, preferably about 700° C. to about 900° C. In the experimental examples to be described later, the underlying electrode layer 32 is formed of a baked layer.

Here, various methods can be used to form the baked layer. For example, a method can be employed in which a conductive paste is extruded from a slit and applied. In this method, by increasing the amount of conductive paste extruded, the underlying electrode layer 32 can be formed not only on the first side surface 12c and the second side surface 12d, but also on a portion of the first main surface 12a and a portion of the second main surface 12b. The baked layer can also be formed using, for example,

a roller transfer method. In the case of the roller transfer method, when forming the underlying electrode layer 32 not only on the first side surface 12c and the second side surface 12d but also on a portion of the first main surface 12a and a portion of the second main surface 12b, the underlying electrode layer 32 can be formed on a portion of the first main surface 12a and a portion of the second main surface 12b by increasing the pressing pressure during roller transfer.

Next, the first underlying electrode layer 32a of the first outer electrode 30a is formed on the first end surface 12e of the fired multilayer body, and the second underlying electrode layer 32b of the second outer electrode 30b is formed on the second end surface 12f.

As with the third underlying electrode layer 32c and the fourth underlying electrode layer 32d, when forming baked layers as the first underlying electrode layer 32a and the second underlying electrode layer 32b, a conductive paste including a glass component and a metal component is applied, followed by baking, to form the underlying electrode layers. The baking temperature is, for example, preferably about 700° C. to about 900° C.

As a method for applying the conductive paste to both end surfaces of the multilayer body, for example, a dipping method or a screen printing method is used. In the experimental examples to be described later, the first underlying electrode layer 32a and the second underlying electrode layer 32b were formed by using the dipping method so as to extend not only to the first end surface 12e and the second end surface 12f, but also to a portion of the first main surface 12a, a portion of the second main surface 12b, a portion of the first side surface 12c, and a portion of the second side surface 12d.

In the baking process, the third underlying electrode layer 32c, the fourth underlying electrode layer 32d, the first underlying electrode layer 32a, and the second underlying electrode layer 32b may be baked simultaneously or separately on the side of both side surfaces 12c and 12d and on the side of both end surfaces 12e and 12f.

When the underlying electrode layer is formed of a baked layer, the baked layer may contain a dielectric component. In this case, the baked layer may contain the dielectric component instead of a glass component, or may include both.

The dielectric component is preferably, for example, the same type of dielectric material as the multilayer body. When the baked layer includes a dielectric component, it is preferable that a conductive paste is applied to a multilayer chip before firing, and the multilayer chip before firing and the conductive paste applied to the multilayer chip before firing are simultaneously baked (fired) to form a multilayer body with the baked layer formed thereon. The baking temperature (firing temperature) is, for example, preferably about 900° C. to about 1400° C.

### Underlying Electrode Layer is Conductive Resin Layer

When the underlying electrode layer 32 is formed of a conductive resin layer, the conductive resin layer can be formed by the following method, for example. The conductive resin layer may be formed on the surface of the baked layer, or may be formed directly on the multilayer body 12 without forming a baked layer.

The conductive resin layer is formed by applying a conductive resin paste including a thermosetting resin and a metal component onto the baking layer or onto the multilayer body 12, followed by heat treatment at a temperature of, for example, about 250° C. to about 550° C., such that the resin is thermally cured and the conductive resin layer is formed. An atmosphere used in this heat treatment is, for example, preferably a N₂ atmosphere. In order to prevent the scattering of the resin and the oxidation of the metal component, the concentration of oxygen is, for example, preferably reduced to about 100 ppm or less.

The conductive resin paste can be applied, for example, by extruding the conductive resin paste through a slit or by roller transfer, as in the case of forming a baked layer as the underlying electrode layer 32.

### Underlying Electrode Layer is Thin Film Layer

When forming a thin film layer as the underlying electrode layer 32, the underlying electrode layer can be formed by, for example, a thin film formation method such as sputtering or vapor deposition, after masking, where the outer electrode 30 is to be formed. The underlying electrode layer formed of a thin film layer is, for example, a layer of about 1 μm or less formed by depositing metal particles.

Next, the plating layer 34 is formed. The plating layer 34 may be formed on the surface of the underlying electrode layer 32, or may be formed directly on the multilayer body 12. In the experimental examples to be described later, the plating layer 34 was formed on the surface of the underlying electrode layer 32. More specifically, a Ni plating layer is formed as a lower plating layer and a Sn plating layer is formed as an upper plating layer on the underlying electrode layer 32. The Ni plating layer and the Sn plating layer are sequentially formed, for example, by barrel plating. Either electrolytic plating or electroless plating may be used for plating, for example. However, electroless plating has the disadvantage that pretreatment with a catalyst or the like is required to improve the plating deposition rate, which complicates the process. Therefore, it is usually preferable to use electrolytic plating.

As described above, the three-terminal multilayer ceramic capacitor 10 according to the present example embodiment is manufactured.

### 3. Experimental Examples

### 3.1 Experimental Example 1

Next, in order to confirm the advantageous effects of the three-terminal multilayer ceramic capacitor according to the present invention described above, a three-terminal multilayer ceramic capacitor was manufactured as an experimental sample by the above-described manufacturing method, and experiments were conducted to measure a DC resistance Rdc1, heat generation characteristics test, humidity resistance reliability test, and ESL.

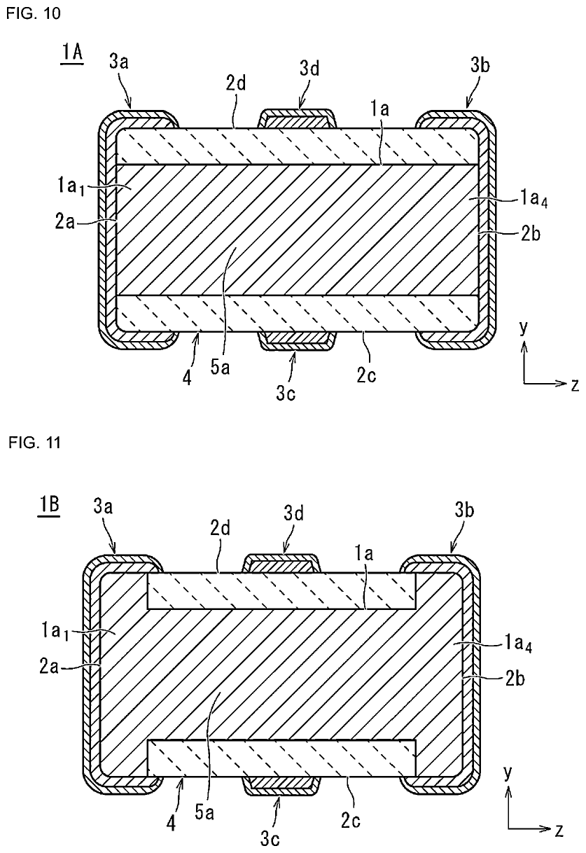

As Example 1, a three-terminal multilayer ceramic capacitor illustrated in FIGS. 1 to 7 was prepared. As Comparative Example 1, a three-terminal multilayer ceramic capacitor using the first inner electrode layer illustrated in FIG. 10 was prepared. As Comparative Example 2, a three-terminal multilayer ceramic capacitor using the first inner electrode layer illustrated in FIG. 11 was prepared.

### (1) Sample of Example 1

First, a three-terminal multilayer ceramic capacitor according to Example 1 with the following specifications was prepared according to the manufacturing method of the multilayer ceramic capacitor described above.

### Example 1

Structure of multilayer ceramic capacitor: 3 terminals (see FIG. 1)
Dimensions of multilayer ceramic capacitor L×W×T (including design values): about 1.750 mm×about 0.945 mm×about 1.275 mm
Material of dielectric layer: BaTiO₃
Electrostatic capacitance: about 10 μF
Rated voltage: about 6.3 V
First inner electrode layer
Material: Ni
Shape: see FIG. 6
Number of sheets: 250
Thickness: about 1.35 μm
Dimension (A1) in the length direction z of the second and third extended electrode portions: about 160 μm
Dimension (A2) in the length direction z of the fifth and sixth extended electrode portions: about 160 μm
Dimension (B1) in the length direction z from the first end surface to the side of the second extended electrode portion on the first end surface side and from the first end surface to the side of the third extended electrode portion on the first end surface side: about 97 μm
Dimension (B2) in the length direction z from the second end surface to the side of the fifth extended electrode portion on the second end surface side and from the second end surface to the side of the sixth extended electrode portion on the second end surface side: about 97 μμm
Second inner electrode layer
Material: Ni
Shape: see FIG. 7
Number of sheets: 250
Thickness: about 1.35 μm
Dimension (E) in the length direction z of the seventh and eighth extended electrode portions: about 175 μm
Structure of outer electrodes
First outer electrode and second outer electrode
Underlying electrode Layer: baked layer including conductive metal (Cu) and a glass component
Thickness at center of end surface: about 48 μm
Plating layer: two-layer structure of Ni plating layer and Sn plating layer
Thickness of Ni plating layer: about 4 μm
Thickness of Sn plating layer: about 4 μm
Dimension (C1) in the length direction z of the portion of the first outer electrode located on a portion of the first main surface and a portion of the second main surface as well as a portion of the first side surface and a portion of the second side surface: about 322 μm
Dimension (C2) in the length direction z of the portion of the second outer electrode located on a portion of the first main surface and a portion of the second main surface as well as a portion of the first side surface and a portion of the second side surface: about 322 μm
Third outer electrode and fourth outer electrode
Underlying electrode Layer: baked layer including conductive metal (Cu) and a glass component
Thickness at center of side surface: about 30 μm
Plating layer: two-layer structure of Ni plating layer and Sn plating layer
Thickness of Ni plating layer: about 6 μm
Thickness of Sn plating layer: about 4 μm
Ratio of the dimension A1 of the second and third extended electrode portions to the dimension C1 of the first outer electrode: about 50% (within the range of about 20% to about 75%)
Ratio of the dimension A2 of the fifth and sixth extended electrode portions to the dimension C2 of the second outer electrode: about 50% (within the range of about 20% to about 75%)

Ratio of the dimension B1 of the second and third extended electrode portions to the dimension C1 of the first outer electrode: about 30% (within the range of about 25% to about 80%)
Ratio of the dimension B2 of the fifth and sixth extended electrode portions to the dimension C2 of the second outer electrode: about 30% (within the range of about 25% to about 80%)

### (2) Samples of Comparative Examples (Comparative Examples 1 and 2)

Next, a three-terminal multilayer ceramic capacitor according to Comparative Example different from Examples in the configuration of the first inner electrode layer was manufactured.

### Comparative Example 1

A three-terminal multilayer ceramic capacitor according to Comparative Example 1 was prepared, including a first inner electrode layer illustrated in FIG. 10 with no second, third, fifth, and sixth extended electrode portions. The other configurations of Comparative Example 1 are the same or substantially the same as that of Example 1.

Specifically, a three-terminal multilayer ceramic capacitor 1A according to Comparative Example 1 includes a rectangular or substantially rectangular first inner electrode layer 1a extending from a first end surface 2a to a second end surface 2b in top view. The first inner electrode layer 1a has a first counter electrode portion 5a, a first extended electrode portion lai, and a fourth extended electrode portion 1a₄. The first extended electrode portion lai extends from the first counter electrode portion 5a in the length direction z, extends to the surface of the first end surface 2a of the multilayer body 4 and is connected to the first outer electrode 3a. The fourth extended electrode portion 1a₄ extends from the first counter electrode portion 5a in the length direction z, extends to the surface of the second end surface 2b of a multilayer body 4 and is connected to the second outer electrode 3b. The first inner electrode layer 1a is not exposed to the first side surface 2c, the second side surface 2d, the first main surface, and the second main surface of the multilayer body 4.

### Comparative Example 2

A three-terminal multilayer ceramic capacitor according to Comparative Example 2 illustrated in FIG. 11 was prepared, in which the first inner electrode layer is also disposed at the corners of the multilayer body 4. The other configurations of Comparative Example 2 is the same or substantially the same as that of Example 1.

Specifically, a three-terminal multilayer ceramic capacitor 1B according to Comparative Example 2 includes a first counter electrode portion 5a, a first extended electrode portion 1a1, and a fourth extended electrode portion 1a₄. The first extended electrode portion 1a extends from the first counter electrode portion 5a in the length direction z, extends to the surfaces of a first end surface 2a, a first side surface 2c, and a second side surface 2d of a multilayer body 4 and is connected to a first outer electrode 3a. The first extended electrode portion lai is continuously extended to the surfaces of the first end surface 2a, the first side surface 2c, and the second side surface 2d, and is exposed on the surface of the multilayer body 4 also at the corners of the multilayer body 4. The fourth extended electrode portion 1a₄ extends from the first counter electrode portion 5a in the length direction z, extends to the surfaces of a second end surface 2b, the first side surface 2c, and the second side surface 2d of the multilayer body 4 and is connected to the second outer electrode 3b. The fourth extended electrode portion 1a₄ is continuously extended to the surfaces of the second end surface 2b, the first side surface 2c, and the second side surface 2d, and is exposed on the surface of the multilayer body 4 also at the corners of the multilayer body 4.

### (3) Experimental Results

For Example 1 and Comparative Examples 1 and 2, the DC resistance Rdc1, heat generation characteristics, humidity resistance reliability, and ESL were measured.

### Measurement of DC Resistance Rdc1

With about 100 mA applied between the first and second outer electrodes, a potential difference between the first and second outer electrodes was measured. The DC resistance Rdc1 was calculated from the formula DC resistance Rdc1=potential difference/100 mA. A value obtained by adding a variation of 3σ to the DC resistance Rdc1 was also calculated.

### Heat Generation Characteristics Test

A heat generation characteristics test was conducted by making a thermocouple come into contact with the surface of the multilayer body of each sample, passing a direct current between the first and second outer electrodes, and measuring a change in the surface temperature of each sample relative to a change in current. The magnitude of the direct current applied to each sample was between 0 A and 7 A, and the temperature change was measured for each magnitude of direct current. A temperature rise value (ΔT) was calculated by subtracting the room temperature from the surface temperature of the multilayer body. Fifty temperature rise values (ΔT) were obtained for each sample, and the average of those values was used as the temperature rise value (ΔT). Samples with the temperature rise value (ΔT) of about 20° C. or lower were counted as pass, while samples with the temperature rise value (ΔT) higher than about 20° C. were counted as failure.

### Humidity Resistance Reliability Test

A humidity resistance reliability test was conducted on each sample based on the PCBT test method. More specifically, each sample was first mounted on a wiring board using eutectic solder. Next, an insulation resistance value of each sample was measured (insulation resistance value before the humidity resistance reliability test time). Then, the wiring board was placed in a high-temperature, high-humidity chamber, and a direct current of about 6.3 V was applied between the first and second outer electrodes of each sample under an environment of about 125° C. and a relative humidity of about 95% RH. This state was maintained for about 144 hours (humidity resistance reliability test time). After the elapse of the humidity resistance reliability test time, the insulation resistance value of each sample was measured (insulation resistance value after humidity resistance reliability test time). For each sample, the insulation resistance value before the humidity resistance reliability test time and the insulation resistance value after the humidity resistance reliability test time were compared, and samples whose insulation resistance value after the humidity resistance reliability test time was reduced by four digits or more as compared to the insulation resistance value before the humidity resistance reliability test time were determined and counted as failure. The humidity resistance reliability test was conducted on seventy samples for Examples 1 to 7 and Comparative Examples 1 and 2, respectively.

### ESL Measurement

Each sample was mounted on a mounting board to prepare a circuit board sample. A voltage was applied between the first and second outer electrodes via the land of the circuit board to measure the ESL value. Specifically, a voltage was applied to each outer electrode, and the ESL was measured with a network analyzer (manufactured by Agilent, model number: E5071B). The ESL was measured for five samples for Examples 1 to 7 and Comparative Examples 1 and 2, respectively, and the average value was calculated. The measurement frequency band was about 100 MHz.

Table 1 shows the experimental results of the DC resistance Rdc1, heat generation characteristics test, ESL, and humidity resistance reliability test for each sample of Example 1, Comparative Example 1, and Comparative Example 2.

TABLE 1

| | | | | | Humidity |
|---|---|---|---|---|---|
| | | | Heat generation | | resistance |
| | | Rdc1 + | characteristics | | reliability test |
| | Rdc1 | 3σ | test (number | ESL | (number of |
| | (mΩ) | (mΩ) | of samples) | (pH) | samples) |
| Example 1 | 0.68 | 0.86 | 0/50 | 108.8 | 0/70 |
| Comparative | 1.66 | 1.84 | 27/50 | 113.6 | 0/70 |
| Example 1 | | | | | |
| Comparative | 0.16 | 0.34 | 0/50 | 108.2 | 7/70 |
| Example 2 | | | | | |

The results in Table 1 show that the three-terminal multilayer ceramic capacitor (Comparative Example 1) including the first inner electrode layer with no second, third, fifth, or sixth extended electrode portion had a large DC resistance. 27 out of 50 samples were determined as failure in the heat generation characteristics test.

As for the three-terminal multilayer ceramic capacitor (Comparative Example 2) with the first inner electrode layer disposed at the corners of the multilayer body, 7 out of 70 samples were determined as failure in the reliability test.

On the other hand, the three-terminal multilayer ceramic capacitor according to Example 1 of the present invention had a low DC resistance of about 0.68 mΩ, less than about 1.65 mΩ, which reduced or prevented heat generation, as well as high humidity resistance reliability and low ESL.

### 3.2 Experimental Example 2

Next, three-terminal multilayer ceramic capacitors including extended electrode portions with different dimensions were manufactured, and experiments were conducted to measure the DC resistance Rdc1, heat generation characteristics test, humidity resistance reliability test, and ESL in the same manner as in Experimental Example 1.

### (1) Samples of Examples (Examples 2 to 7)

### Example 2

A three-terminal multilayer ceramic capacitor was prepared so that the dimension A1 of the second and third extended electrode portions was about 48.3 μm and the dimension A2 of the fifth and sixth extended electrode portions was about 48.3 μm in the three-terminal multilayer ceramic capacitor of Example 1. In this event, the ratio of the dimension A1 of the second and third extended electrode portions to the dimension C1 of the first outer electrode was about 15%. The ratio of the dimension A2 of the fifth and sixth extended electrode portions to the dimension C2 of the second outer electrode was about 15%. The other configuration is the same as that of Example 1.

### Example 3

A three-terminal multilayer ceramic capacitor was prepared so that the dimension A1 of the second and third extended electrode portions was about 64.4 μm and the dimension A2 of the fifth and sixth extended electrode portions was about 64.4 μm. In this event, the ratio of the dimension A1 of the second and third extended electrode portions to the dimension C1 of the first outer electrode was about 20%. The ratio of the dimension A2 of the fifth and sixth extended electrode portions to the dimension C2 of the second outer electrode was about 20%. The other configuration is the same as that of Example 1.

### Example 4

A three-terminal multilayer ceramic capacitor was prepared so that the dimension A1 of the second and third extended electrode portions was about 103 μm and the dimension A2 of the fifth and sixth extended electrode portions was about 103 μm. In this event, the ratio of the dimension A1 of the second and third extended electrode portions to the dimension C1 of the first outer electrode was about 32%. The ratio of the dimension A2 of the fifth and sixth extended electrode portions to the dimension C2 of the second outer electrode was about 32%. The other configuration is the same as that of Example 1.

### Example 5

The three-terminal multilayer ceramic capacitor of Example 1 was used as Example 5.

### Example 6

A three-terminal multilayer ceramic capacitor was prepared so that the dimension A1 of the second and third extended electrode portions was about 242 μm and the dimension A2 of the fifth and sixth extended electrode portions was about 242 μm. In this event, the ratio of the dimension A1 of the second and third extended electrode portions to the dimension C1 of the first outer electrode was about 758. The ratio of the dimension A2 of the fifth and sixth extended electrode portions to the dimension C2 of the second outer electrode was about 758. The other configuration is the same as that of Example 1.

### Example 7

A three-terminal multilayer ceramic capacitor was prepared so that the dimension A1 of the second and third extended electrode portions was about 257.6 μm and the dimension A2 of the fifth and sixth extended electrode portions was about 257.6 μm in the three-terminal multilayer ceramic capacitor of Example 1. In this event, the ratio of the dimension A1 of the second and third extended electrode portions to the dimension C1 of the first outer electrode was about 808. The ratio of the dimension A2 of the fifth and sixth extended electrode portions to the dimension C2 of the second outer electrode was about 80%. The other configuration is the same as that of Example 1.

Table 2 shows the experimental results of the DC resistance Rdc1, heat generation characteristic test, ESL, and humidity resistance reliability test for each sample of Examples 2 to 7.

TABLE 2

| | | | | | Heat generation | | Humidity resistance |
|---|---|---|---|---|---|---|---|
| | A1/C1 | A2/C2 | Rdc1 | Rdc1 + 3σ | characteristics test | ESL | reliability test |
| | (%) | (%) | (mΩ) | (mΩ) | (number of samples) | (pH) | (number of samples) |
| Example 2 | 15 | 15 | 1.49 | 1.68 | 1/50 | 107.7 | 0/70 |
| Example 3 | 20 | 20 | 1.33 | 1.52 | 0/50 | 107.8 | 0/70 |
| Example 4 | 32 | 32 | 1.02 | 1.20 | 0/50 | 106.8 | 0/70 |
| Example 5 | 50 | 50 | 0.68 | 0.86 | 0/50 | 108.8 | 0/70 |
| Example 6 | 75 | 75 | 0.38 | 0.57 | 0/50 | 107.9 | 0/70 |
| Example 7 | 80 | 80 | 0.34 | 0.53 | 0/50 | 105.9 | 2/70 |

From the results in Table 2, 1 of 50 samples was determined as failure in the heat generation test in Example 2 where A1/C1 was about 15% and A2/C2 was about 15%. The DC resistance with the variation 30 taken into account was about 1.68 mΩ, which was higher than about 1.65 mΩ, making it difficult to reduce or prevent heat generation.

In Example 7 where A1/C1 was 80% and A2/C2 was about 80%, 2 out of 70 samples were determined as failure in the reliability test.

On the other hand, Examples 3 to 6 where A1/C1 was 20% to 75% and A2/C2 was about 20% to about 75% showed a low DC resistance, which reduced or prevented heat generation, as well as high humidity resistance reliability and low ESL.

As described above, the example embodiments of the present invention have been disclosed in the above description, but the present invention is not limited thereto.

In other words, various modifications can be made to the above-described example embodiments in terms of configuration, shape, material, quantity, position, arrangement or the like, without departing from the scope of the technical idea and purpose of the present invention, and such modifications are included in the present invention.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A three-terminal multilayer ceramic capacitor comprising:
a multilayer body including a plurality of laminated dielectric layers and including a first main surface and a second main surface that face each other in a height direction, a first end surface and a second end surface that face each other in a length direction orthogonal or substantially orthogonal to the height direction, and a first side surface and a second side surface that face each other in a width direction orthogonal or substantially orthogonal to the height direction and the length direction;
a plurality of first inner electrode layers on the plurality of dielectric layers and extending to the first end surface and the second end surface as well as the first side surface and the second side surface;
a plurality of second inner electrode layers on the plurality of dielectric layers and extending to the first side surface and the second side surface;
a first outer electrode on the first end surface, extending from the first end surface to a portion of the first main surface and a portion of the second main surface and on a portion of the first side surface and a portion of the second side surface, and being connected to the first inner electrode layers;
a second outer electrode on the second end surface, extending from the second end surface to a portion of the first main surface and a portion of the second main surface and on a portion of the first side surface and a portion of the second side surface, and being connected to the first inner electrode layers;
a third outer electrode on the first side surface, extending from the first side surface to a portion of the first main surface and a portion of the second main surface, and being connected to the second inner electrode layers; and
a fourth outer electrode on the second side surface, extending from the second side surface to a portion of the first main surface and a portion of the second main surface, and being connected to the second inner electrode layers; wherein the first inner electrode layers each include:
a first counter electrode portion facing the second inner electrode layers with the plurality of dielectric layers interposed therebetween;
a first extended electrode portion extending from the first counter electrode portion and to the first end surface and connected to the first outer electrode;
a second extended electrode portion extending from the first counter electrode portion or the first extended electrode portion to the first side surface at a position spaced away from the first end surface on a first end surface side and connected to the first outer electrode;
a third extended electrode portion extending from the first counter electrode portion or the first extended electrode portion to the second side surface at a position spaced away from the first end surface on the first end surface side and connected to the first outer electrode;
a fourth extended electrode portion extending from the first counter electrode portion to the second end surface and connected to the second outer electrode;
a fifth extended electrode portion extending from the first counter electrode portion or the fourth extended electrode portion to the first side surface at a position spaced away from the second end surface on a second end surface side and connected to the second outer electrode; and
a sixth extended electrode portion extending from the first counter electrode portion or the fourth extended electrode portion to the second side surface at a position spaced away from the second end surface on the second end surface side and connected to the second outer electrode.

2. The three-terminal multilayer ceramic capacitor according to claim 1, wherein the second inner electrode layers each include:
a second counter electrode portion facing the first counter electrode portion with the plurality of dielectric layers interposed therebetween;
a seventh extended electrode portion extending from the second counter electrode portion to the first side surface; and
an eighth extended electrode portion extending from the second counter electrode portion to the second side surface.

3. The three-terminal multilayer ceramic capacitor according to claim 1, wherein a dimension in the length direction from the first end surface to a side of the second extended electrode portion on the first end surface side and from the first end surface to a side of the third extended electrode portion on the first end surface side is more than or equal to about 25% and less than or equal to about 80% of a dimension in the length direction of a portion of the first outer electrode on a portion of the first main surface and a portion of the second main surface, and on a portion of the first side surface and a portion of the second side surface; and
a dimension in the length direction from the second end surface to a side of the fifth extended electrode portion on the second end surface side and from the second end surface to a side of the sixth extended electrode portion on the second end surface side is more than or equal to about 25% and less than or equal to about 80% of a dimension in the length direction of a portion of the second outer electrode on a portion of the first main surface and a portion of the second main surface, and on a portion of the first side surface and a portion of the second side surface.

4. The three-terminal multilayer ceramic capacitor according to claim 1, wherein a dimension in the length direction of the second extended electrode portion and the third extended electrode portion is more than or equal to about 20% and less than or equal to about 75% of a dimension in the length direction of a portion of the first outer electrode on a portion of the first main surface and a portion of the second main surface, and on a portion of the first side surface and a portion of the second side surface; and
a dimension in the length direction of the fifth extended electrode portion and the sixth extended electrode portion is more than or equal to about 20% and less than or equal to about 75% of a dimension in the length direction of a portion of the second outer electrode on a portion of the first main surface and a portion of the second main surface, and on the first side surface and a portion of the second side surface.

5. The three-terminal multilayer ceramic capacitor according to claim 1, wherein each of the plurality of dielectric layers includes BaTiO₃, CaTio3, SrTiO₃, or CaZrO₃ as a main component.

6. The three-terminal multilayer ceramic capacitor according to claim 5, wherein each of the plurality of dielectric layers includes a Mn compound, a Fe compound, a Cr compound, a Co compound, or a Ni compound as a subcomponent.

7. The three-terminal multilayer ceramic capacitor according to claim 1, wherein a thickness of each of the plurality of dielectric layers is about 0.5 μm and smaller than or equal to about 10.0 μm.

8. The three-terminal multilayer ceramic capacitor according to claim 1, wherein a number of the plurality of dielectric layers is larger than or equal to 15 and smaller than or equal to 600.

9. The three-terminal multilayer ceramic capacitor according to claim 1, wherein a dimension of the second, third, fifth, and sixth extended electrode portions in the length direction are the same or substantially the same.

10. The three-terminal multilayer ceramic capacitor according to claim 2, wherein dimension of the seventh and eighth extended electrode portions is about 100 μm to about 400 μm.

11. The three-terminal multilayer ceramic capacitor according to claim 1, wherein a total number of the plurality of first and second inner electrode layers is 15 to 500.

12. The three-terminal multilayer ceramic capacitor according to claim 1, wherein each of the plurality of first and second inner electrode layers includes Ni, Cu, Ag, Pd, or Au, or an alloy including at least one of Ni, Cu, Ag, Pd, or Au.

13. The three-terminal multilayer ceramic capacitor according to claim 1, wherein a thickness of each of the plurality of first and second inner electrode layers is about 0.5 μm to about 1.0 μm.

14. The three-terminal multilayer ceramic capacitor according to claim 1, wherein each of the first, second, third, and fourth outer electrodes includes an underlying electrode layer and a plating layer on a surface of the underlying electrode layer.

15. The three-terminal multilayer ceramic capacitor according to claim 14, wherein the underlying electrode layer includes a baked layer including a glass component and a metal component.

16. The three-terminal multilayer ceramic capacitor according to claim 15, wherein the glass component includes at least one of B, Si, Ba, Mg, Al, or Li.

17. The three-terminal multilayer ceramic capacitor according to claim 15, wherein the metal component includes at least one of Cu, Ni, Ag, Pd, Ag-Pd alloy, or Au.

18. The three-terminal multilayer ceramic capacitor according to claim 14, wherein a thickness of the underlying electrode layer is about 3 μm to about 20 μm.
